(19) United States
(12) Patent Application Publication
(10) Pub. No.: US 2005/0035516 A1
(43) Pub. Date: Feb. 17, 2005

(54) Sealed pin locator clamp

(76) Inventors: Edwin G. Sawdon, St. Clair, MI (US); Ryan A. Bastick, St. Clair, MI (US)

Correspondence Address: HARNESS, DICKEY & PIERCE, P.L.C., P.O. BOX 828, BLOOMFIELD HILLS, MI, 48303, US

(21) Appl. No.: 10/641,987

(22) Filed: Aug. 14, 2003

(51) Int. Cl. B23Q 3/08

(52) U.S. Cl. 269/32

(57) ABSTRACT

A sealed pin locator clamp includes an actuator having a linearly drivable member, a clamp body, a locating pin coupled to and protruding from the clamp body and a clamping member slidably positioned within an arcuate slot formed in the pin. The clamping member is drivingly coupled to the actuator and selectively moveable between a first position inside the pin and a second position at least partially protruding from the pin.

### BACKGROUND AND SUMMARY OF THE INVENTION

The present invention relates generally to a clamp and, more particularly, to a fluid powered, sealed pin locator clamp.

Powered clamps have been commonly used to secure workpieces, such as sheet metal automotive body panels, polymeric parts and the like in checking fixtures, gauging stations, welding station, punching stations and other locations within a manufacturing environment. Many existing clamps are powered by hydraulic or pneumatic fluid pressure. For example, reference should be made to the following U.S. patents, which have been invented by Sawdon: U.S. Pat. No. 6,502,880 entitled “Pin Part Locator” which issued on Jan. 7, 2003; U.S. Pat. No. 6,378,855 entitled “Locking Pin Clamp” which issued on Apr. 30, 2002; U.S. Pat. No. 5,190,330 entitled “Powered Clamp with Parallel Jaws” which issued on Mar. 2, 1993; all of which are incorporated by reference herein.

It is desirable to prevent a clamping arm from opening and releasing the workpiece if there is a loss of fluid pressure. Prior constructions employing such a feature are disclosed in U.S. Pat. No. 5,871,250 entitled “Sealed Straight Line Gripper” which issued to Sawdon on Feb. 16, 1999 and U.S. Pat. No. 5,853,211 entitled “Universal Gripper” which issued to Sawdon et al. on Dec. 29, 1998. These patents are also incorporated by reference herein.

In accordance with the present invention, a sealed pin locator clamp includes an actuator operably moveable in a linear direction, a clamp body, a pin coupled to the clamp body and an arcuate clamping member. The pin includes an external surface and an internal arcuate slot in communication with the external surface. The arcuate clamping member is positioned within the arcuate slot and drivingly coupled to the actuator. The clamping member is selectively moveable between a first position inside the pin and a second position at least partially protruding from the pin. The clamping member is operable to exert a force toward an anvil to temporarily secure a workpiece to the sealed pin locator clamp.

The sealed pin locator clamp of the present invention is highly advantageous over traditional clamps in that the clamp includes an arcuate clamping member contained within a precise slot of a locating pin. The clamping member is moveable in response to the application of pressurized fluid to a sealed chamber. This design eliminates exposing the inner mechanism to contamination such as weld flash, metal shavings or coatings on the metal which may rub off when parts are loaded over the pin locator clamp. Additionally, the arcuate clamping member is rotatable from a position inside the pin to a position outside the pin such that the workpiece may be freely positioned over the pin when the clamping member is retracted and firmly held in place when the clamping member is extended.

In addition, the present invention optionally includes a self-locking mechanism which does not allow the clamping mechanism to retract if fluid actuation pressure is lost. A first embodiment includes a spring to supply load to the clamping member in the event of pressure loss. An alternate embodiment includes a lock pin which engages a piston to resist retraction of the clamping member. The lock pin may be released via fluid pressure once pressure returns to the system or manually by pulling an external portion of the pin.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a side elevational view showing a first embodiment sealed pin locator clamp constructed in accordance with the teachings of the present invention;

FIG. 2 is a perspective view of the first embodiment sealed pin locator clamp;

FIG. 3 is a exploded perspective view of the first embodiment sealed pin locator clamp;

FIG. 4 is a side view cross-sectional view of the first embodiment sealed pin locator clamp having a clamping member in an extended position;

FIG. 5 is a cross-sectional side view of the first embodiment sealed pin locator clamp having the clamping member in a retracted position;

FIG. 6 is a partial side view depicting the interconnection between the clamping member and a link of the sealed pin locator clamp;

FIG. 7 is a partial fragmentary top view depicting the clamping member and link interconnection;

FIG. 8 is a partial cross-sectional side view of a second embodiment sealed pin locator clamp;

FIG. 9 is a partial cross-sectional side view depicting another alternate embodiment sealed pin locator clamp having an enlarged locator pin with an optional second clamping member;

FIG. 10 is a cross-sectional side view depicting an alternate embodiment sealed pin locator clamp having a manually releasable locking pin;

FIG. 11 is a partial top view depicting the clamping member and link interconnection of the alternate embodiment sealed pin locator clamp shown in FIG. 10; and

FIG. 12 is a partial top view of an alternate embodiment sealed pin locator clamp having a quick change pin mount.

### DETAILED DESCRIPTION OF THE PREFERRED EMBODIMENTS

The following description of the preferred embodiments is merely exemplary in nature and is in no way intended to limit the invention, its application, or uses.

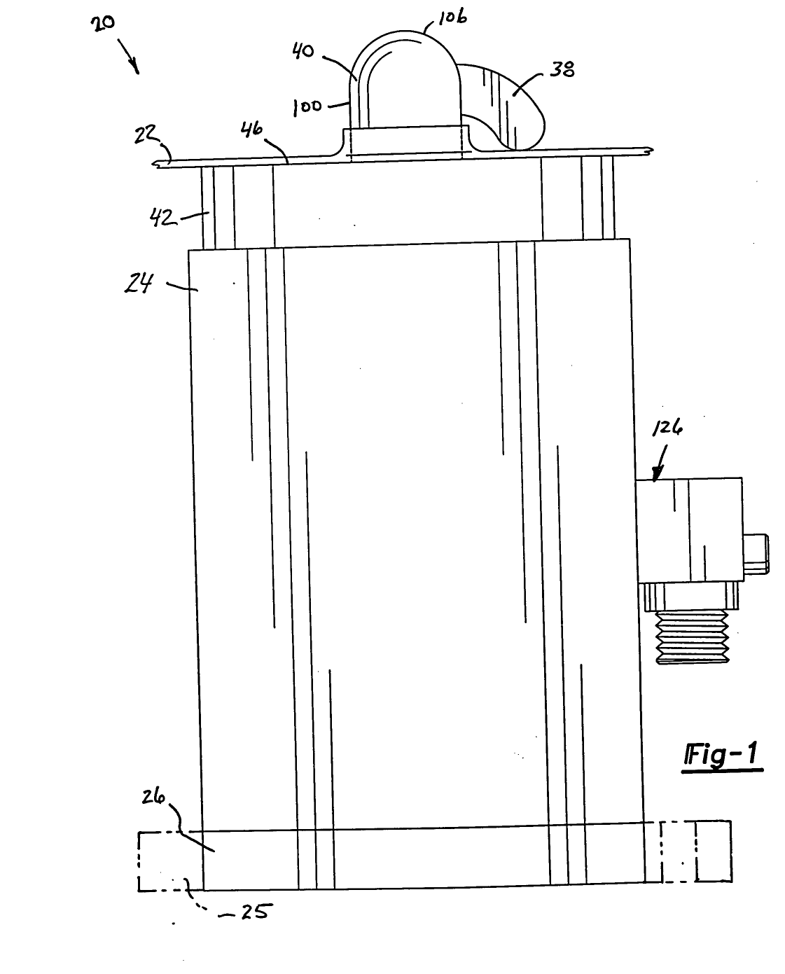

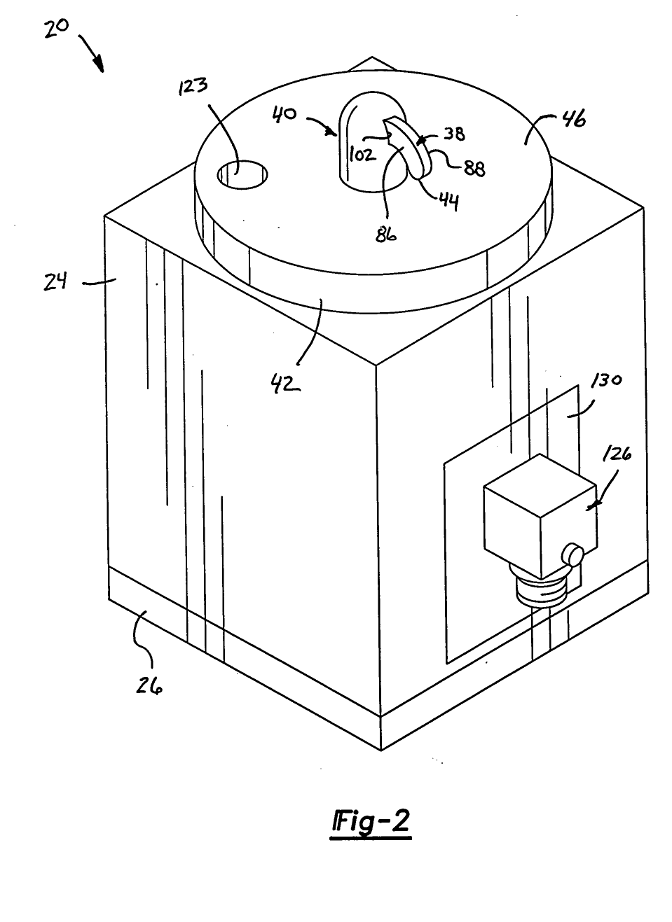

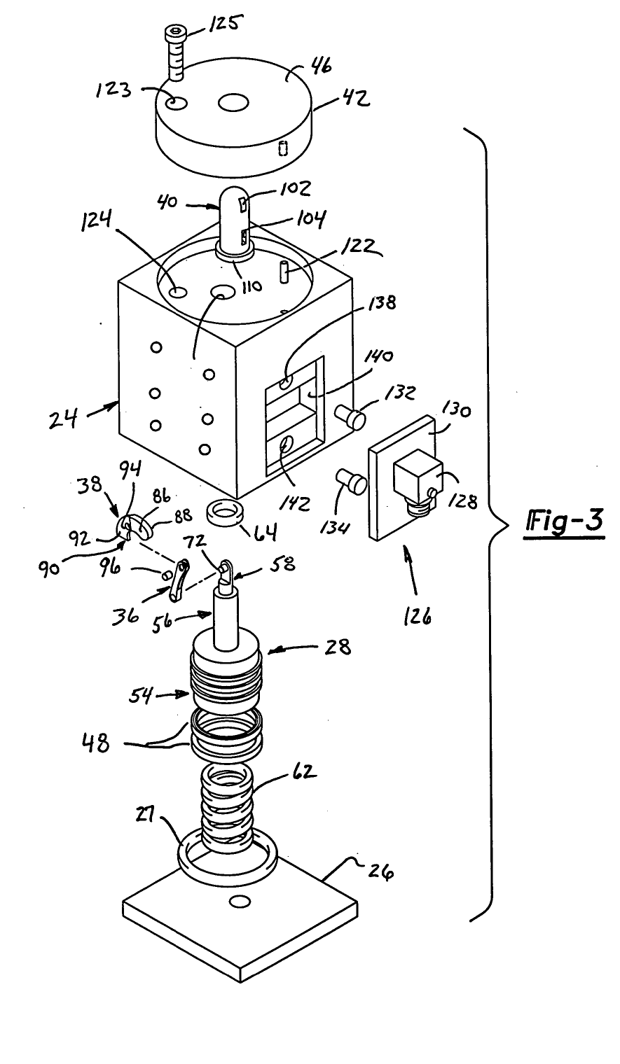

Referring to FIGS. 1-7, a first embodiment of a locking pin clamp 20 of the present invention is used to locate or gauge and then clamp a workpiece 22 in a work station such as a moving assembly line, in a start-stop manufacturing station or in an off-line work cell. A clamp body 24 is coupled to a base 26 which in turn may be mounted to a table or attached to an end effector secured to a robotic arm. A seal 27 is positioned between body 24 and base 26. Clamp body 24 may be alternatively shaped to include a cylindrical outer surface. Also, base 26 may be extended to include a flange 25 shown in phantom line representation. Flange 25 includes at least one aperture to assist in mounting pin clamp 20. Body 24 is preferably machined with a NAAMS hole pattern on one or more sides. Base 26 also includes a NAAMS hold pattern to aid in mounting pin clamp 20. Accordingly, workpiece 22 may be moved relative to a stationarily mounted clamp 20 or clamp 20 may be moved relative to a stationarily mounted workpiece.

Clamp 20 includes a piston 28 slidably positioned within a stepped bore 30. Stepped bore 30 includes a first bore 31 and a second bore 32. First bore 31 is coaxially aligned with second bore 32. Stepped bore 30 includes a longitudinal axis 34 offset from a longitudinal axis 35 of body 24. Locking pin clamp 20 also includes a link 36, a clamping member 38, a pin 40 and an anvil 42.

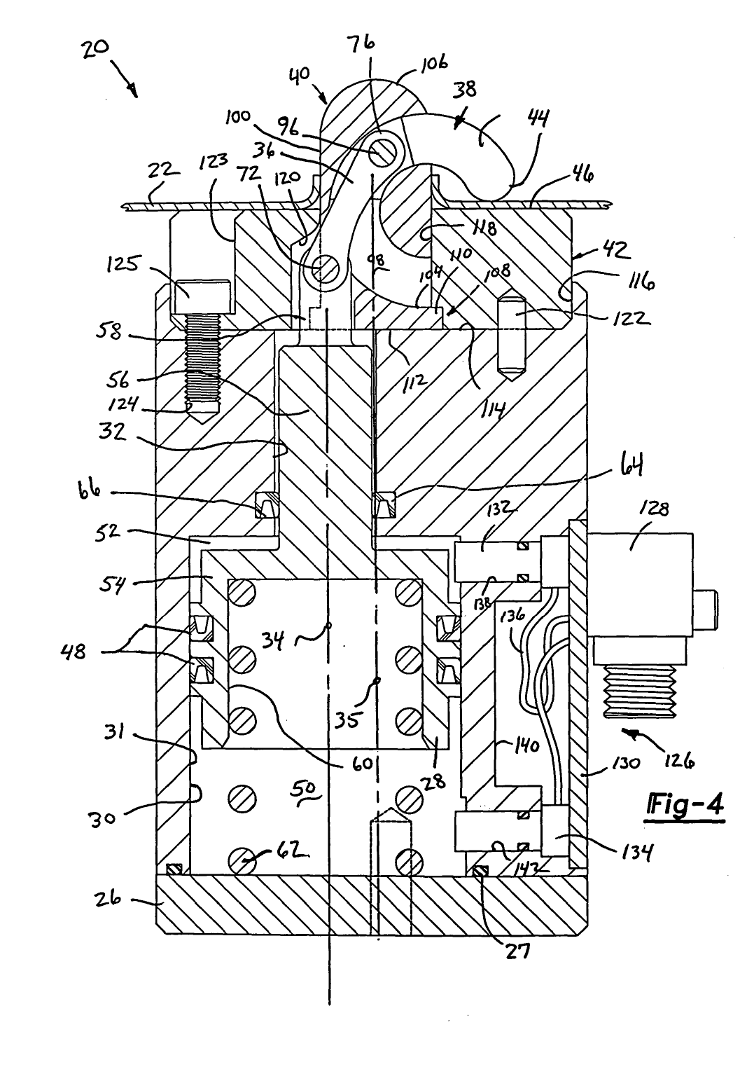

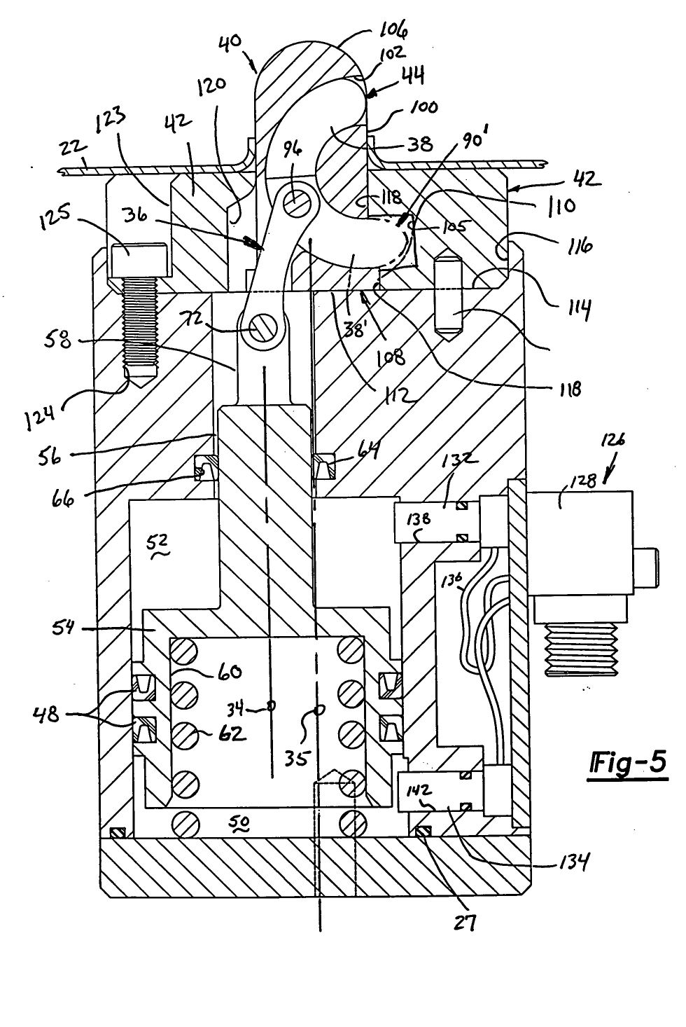

Piston 28, link 36 and clamping member 38 are drivingly coupled to one another to move clamping member 38 between an extended or clamping position shown in FIG. 4 to a retracted position shown in FIG. 5. In the extended position, a distal end 44 of clamping member 38 exerts force on workpiece 22 which is reacted by an upper surface 46 of anvil 42. First end 44 may be rounded as depicted in the Figures, or may alternately include a flat. The flat would be oriented at an angle to upper surface 46 to maintain a line contact with workpiece 22. A pair of seals 48 are coupled to piston 28 to sealingly engage first bore 31. Seals 48 define a first chamber 50 and a second chamber 52. Pressurized fluid is supplied to first chamber 50 to translate piston 28 and move clamping member 38 toward the extended position. Second chamber 52 is selectively supplied with pressurized fluid to move piston 28 in an opposite direction toward base 26 thereby moving clamping member toward the retracted position of FIG. 5.

Piston 28 includes a substantially cylindrical first section 54, a substantially cylindrical second section 56 axially extending from first section 54, and a third section 58 axially extending from second section 56. First section 54 includes a spring bore 60 for receipt of a spring 62. Spring 62 is a compression spring and is shown in a pre-loaded position in FIG. 4. Accordingly, if pressurized fluid is not supplied to first chamber 50 or second chamber 52, a force is exerted from clamping member 38 to anvil 42. Spring 62 assures that at least a minimum force is exerted on workpiece 22 should the pressurized fluid source be compromised during a manufacturing operation.

Second section 56 is slidably positioned within second bore 32. A seal 64 is positioned within a pocket 66 formed within second bore 32. As is clearly shown in the Figures, third section 58 defines a smaller effective diameter than second section 56 while second section 56 defines a smaller effective diameter when compared to first section 54. The transition from first section 54 to second section 56 of piston 28 is axially positioned to allow clamping member 38 to engage workpieces 22 having a wide variety of thicknesses. In particular, the axial location of the transition from first section 54 to second section 56 of piston 28 allows extended linear travel of piston 28 to ensure a sufficient clamp force is generated on the different thickness materials.

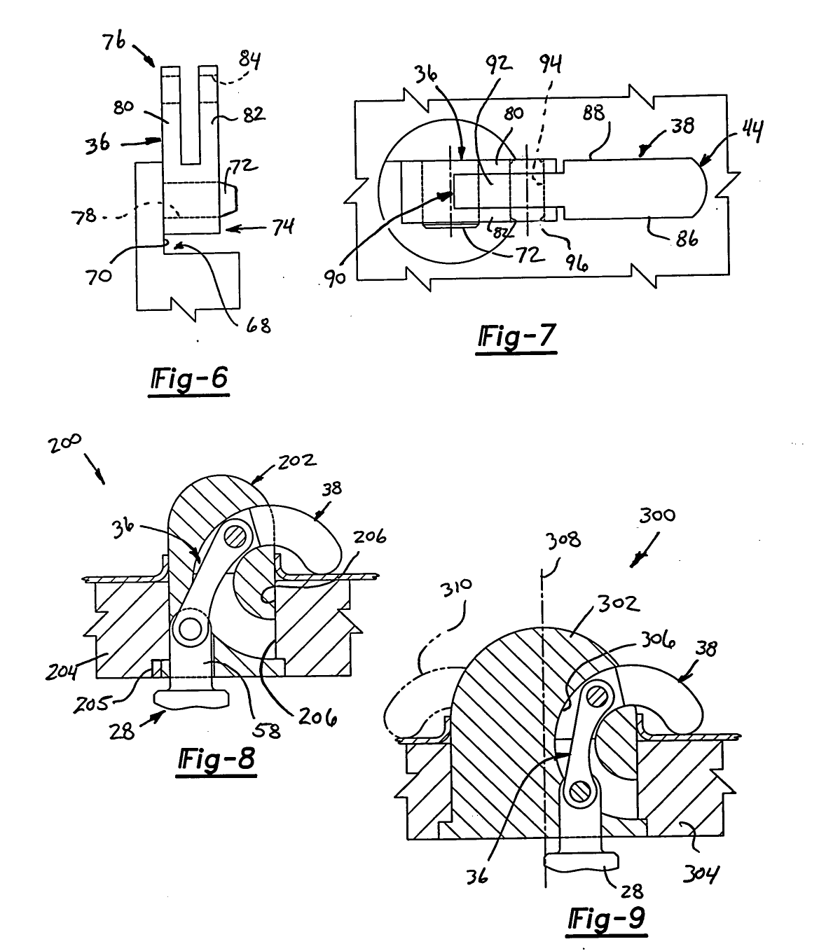

As most clearly shown in FIGS. 6 and 7, third section 58 is substantially cylindrical including a notch 68 having a flat 70. A post 72 laterally extends from flat 70 transverse to longitudinal axis 34. Link 36 includes a first end 74 and a bifurcated second end 76. First end 74 includes an aperture 78 in receipt of post 72. Post 72 and aperture 78 are sized such that link 36 is free to rotate about the longitudinal axis of post 72. Bifurcated second end 76 includes first leg 80 and a second leg 82. Each of the first and second legs includes an aperture 84 positioned along a common axis.

Clamping member 38 is a generally flat arcuately shaped member. Distal end 44 includes a substantially planar first face 86 and a substantially planar second face 88 offset and parallel to first face 86. A proximal end 90 of clamping member 38 has a reduced thickness from distal end 44 to define a web 92. An aperture 94 extends transversely through web 92 to accommodate a pin 96 which rotatably interconnects clamping member 38 and link 36. Specifically, pin 96 extends through first leg 80, web 92 and second leg 82. Clamping member 38, pin 96 and bifurcated second end 76 of link 36 are slidably positioned within an arcuate slot 98 formed in pin 40. Arcuate slot 98 includes a generally rectangular cross-section and communicates with an external surface 100 of pin 40 at both an upper aperture 102 and a lower aperture 104. Clamping member 38 is sized to closely conform to the dimensions of arcuate slot 98. Therefore, locking pin clamp 20 operates as a self-sealing and self-cleaning apparatus. Additionally, upper aperture 102 is exposed to the work cell environment. To further reduce the possibility of contamination, aperture 102 is substantially vertically oriented in most applications. The vertical orientation substantially reduces the likelihood of contaminant entry.

An alternate clamping member 38′ is shown in FIG. 5 in phantom line representation. Alternate clamping member 38′ spans an extended arc length. The extended arc length provides greater support for clamping member 38′ during operation. A recess 105 is formed in anvil 42 to accept proximal end 90 and account for the increased length of clamping member 38′.

Pin 40 is a substantially cylindrical member having a spherically-shaped first end 106 and a second end 108. Second end 108 includes a flange 110 having a bottom surface 112 supported by a land 114 of a recess 116 formed at one end of body 24. Anvil 42 is a substantially disc-shaped member having a counterbore 118 extending therethrough. Counterbore 118 is sized for receipt of flange 110 and the cylindrical portion of pin 40. One skilled in the art will appreciate that pin 40 may be constructed having any number of geometrical cross-sectional shapes and the cylindrical shape described is merely exemplary. Anvil 42 further includes an internal relief 120 sized to accommodate the articulated positions of link 36 and piston 28. A roll pin 122 couples and aligns anvil 42 with body 24. Furthermore, a fastener counterbore 123 is aligned with an internally threaded passageway 124 of body 24. A threaded fastener 125 couples pin 40 and anvil 42 to body 24.

As best shown in FIGS. 4 and 5, a proximity switch assembly 126 is configured to signal an electronic controller (not shown) or a user when piston 28 is located near the top or bottom of first bore 31. More particularly proximity switch assembly 126 includes a housing 128, an access plate 130, a first sensor head 132, a second sensor head 134 and wire 136 interconnecting the sensor heads and housing 128. First sensor head 132 is positioned within a first transverse bore 138. Transverse bore 138 extends from first bore 31 to a switch pocket 140 formed in body 24. Second sensor head 134 is positioned within a second transverse bore 142. Second transverse bore is in communication with first bore 31 and pocket 140. First sensor head 132 and second sensor head 134 are positioned to detect the presence or absence of piston 28. Each sensor head outputs a signal when the piston is within a predetermined proximity of an end face of the sensor head. In this manner, a controller or an operator is notified that clamping member 38 is in the extended position, retracted position or somewhere therebetween depending on the signals output from proximity switch assembly 126.

FIG. 8 depicts an alternate embodiment locking pin clamp 200. Locking pin clamp 200 is substantially similar to locking pin clamp 20. Accordingly, like numerals will be used to identify previously introduced elements. Locking pin clamp 200 utilizes clamping member 38, link 36, piston 28 and body 24 common to clamp 20. An enlarged pin 202 is coupled to body 24 via an anvil 204. Pin 202 includes a locating lug 205 to prevent loss of orientation of pin 202 and anvil 204 thus preventing possible binding. Anvil 204 includes a correspondingly enlarged bore 206 extending therethrough. Link 36 and third section 58 of piston 28 are positioned within the boundary defined by counterbore 206. Therefore, anvil 204 of second pin clamp 200 does not require the special machining of a relief such as previously described in relation to anvil 42.

FIG. 9 depicts another alternate embodiment locking pin clamp 300. Locking pin clamp 300 is substantially similar to the previously described locking pin clamps. Accordingly, like elements will maintain their previously introduced reference numerals. Locking pin clamp 300 is also designed to utilize common clamping member 38, link 36, piston 28 and body 24. Locking pin clamp 300 includes a relatively large pin 302 extending through an appropriately sized anvil 304. Piston 28 and link 36 articulate through apertures formed in pin 302. Accordingly, special machining is not required of anvil 304. Additionally, an arcuate slot 306 formed in pin 302 is positioned to one side of a pin longitudinal axis 308. Based on this positioning of componentry, an optional second clamping member 310 may be selectively driven from a retracted position to an extended position as previously described in relation to clamping member 38. Preferably, second clamping member is drivingly coupled to a new single piston (not shown) having a pair of links coupled thereto.

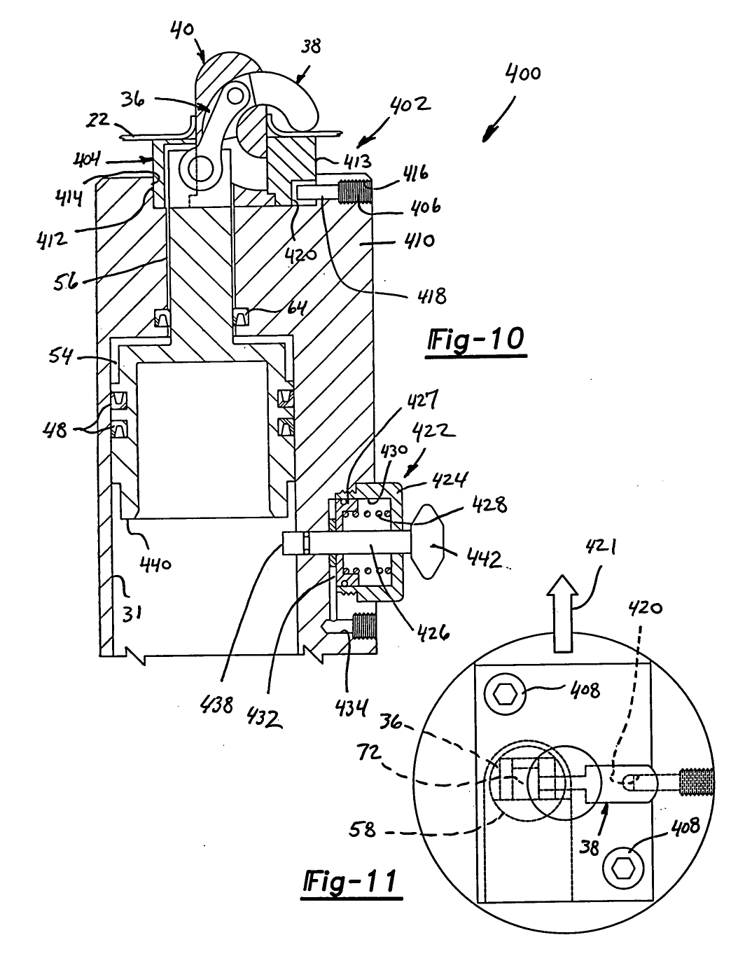

FIGS. 10 and 11 depict another alternate embodiment locking pin clamp 400. Locking pin clamp 400 is constructed substantially similarly to the locking pin clamps previously described. Accordingly, like elements will retain their previously introduced reference numerals. Locking pin clamp 400 includes a quick change pin mount 402 including an anvil 404, a locating pin 406 and a pair of threaded fasteners 408. Pin mount 402 facilitates rapid changing of pin 40 should the need arise during use. Anvil 404 is a substantially rectangular component including parallel sides 412 and 413. Locking pin clamp 400 includes a body 410 having a slot 414 sized to receive anvil 404. Locating pin 406 is threadingly engaged with a threaded passage 416 transversely extending through body 410. Locating pin 406 includes an unthreaded section 418 selectively positionable within key way 420.

To disassemble pin mount 402 from clamp 400, threaded fasteners 408 and locating pin 406 are removed from the assembly. At this time, anvil 404, pin 40, clamping member 38 and link 36 may be linearly displaced in the direction of arrow 421 to disengage first end 74 of link 36 from post 72 of piston 28. At this time, a differently or similarly sized pin replacement pin and anvil may be assembled to clamp 400 by simply reversing the procedure of connecting link 36 to piston 28, inserting locating pin 406 within key way 420 and installing threaded fasteners 408 to fix anvil 404 to body 410.

Clamp 400 also includes a locking assembly 422. Locking assembly 422 includes a housing 424, a pull pin 426, a piston 427 and a return spring 428. Piston 427 is mounted on pull pin 426 and slidably positioned within a bore 430 of housing 424. Housing 424 is threadingly coupled to body 410 to define a cavity 432 in communication with a port 434. Pull pin 426 includes a first end 438 selectively positionable within first bore 31 or adjacent to first bore 31.

During actuation, pressure is normally supplied to port 434 to cause piston 427 to position first end 438 of pull pin 426 clear of piston 28. If the supply of pressurized fluid to clamp 400 is interrupted, return spring 428 causes first end 438 of pull pin 426 to enter first bore 31 and engage an end surface 440 of piston 28 thereby limiting the amount of return travel clamping member 38 may incur.

If pressure is returned to the system, piston 427 compresses spring 428 to clear pull pin 426 from piston 28. If, however, it is desirable to move clamping member 38 to the retracted position without a pressurized fluid source, a tang 442 of pull pin 426 may be grasped to overcome the force supplied by return spring 428 to allow piston 28 to pass end 438.

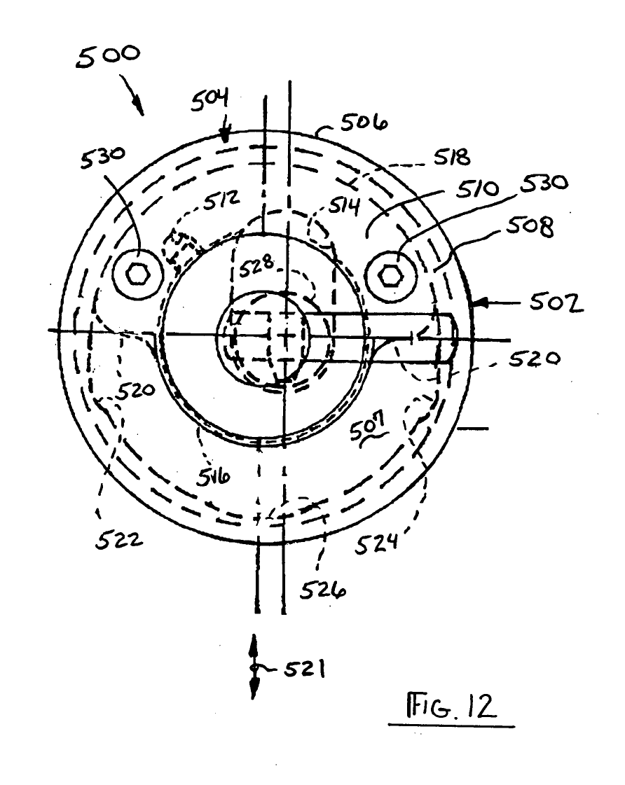

FIG. 12 depicts an alternate pin mount 500 including a substantially cylindrical anvil 502 coupled to clamp body 504. Clamp body 504 includes a substantially cylindrical outer surface 506. Body 504 includes a recess 507 defined by an upstanding wall 508.

Anvil 502 includes a semi-cylindrical downstanding boss 510, a pocket 512 and a slot 514. Downstanding boss 510 forms a stepped profile engageable with upstanding wall 508 of body 504. Boss 510 includes an inner semi-cylindrical portion 516 and an outer semi-cylindrical portion 518. When assembled, outer semi-cylindrical portion 518 engages wall 508. End surfaces 520 are formed at the transition of outer semi-cylindrical portion 518 and inner semi-cylindrical portion 516. Recess 507 includes first, second and third notches 522, 524 and 526, respectively. The notches are positioned to allow relative movement of anvil 502 relative to body 504 in a first transverse direction along line 521. The translational movement of anvil 502 relative to body 504 is limited when end surfaces 520 of boss 510 engage first notch 522 and second notch 524. At substantially the same time, inner semi-cylindrical portion 516 engages third notch 526. Slot 514 provides clearance to a portion of a piston 528 to allow anvil 50 to move relative to body 504 as previously described. A pair of fasteners 530 couple anvil 502 to body 504. Pin mount 500 may be disassembled from the clamp by simply removing fasteners 524 and sliding anvil 502 transversely relative to body 504 and then lifting anvil 502 off of body 504.

It should be appreciated that the embodiments shown are merely exemplary in nature and that a number of variations may be made to the embodiments without departing from the scope of the present invention. Specifically, the link to piston interconnection may be accomplished using a removable roll pin in lieu of the integrally formed post previously described. Additionally, functioning embodiments of the clamp need not include a mechanism for maintaining the position of the clamping member during a loss of pressure. Therefore, the assemblies could be further simplified by removing the return spring and/or the locking assembly.

1. A clamp comprising:
an actuator operably moveable in a linear direction;
a clamp body;
a pin coupled to said clamp body, said pin including an external surface and an internal arcuate slot in communication with said external surface; and
an arcuate clamping member positioned within said arcuate slot and drivingly coupled to said actuator, said clamping member being selectively moveable between a first position inside said pin and a second position at least partially protruding from said pin.

2. The clamp of claim 1 wherein said actuator includes a piston slidably positioned within a bore of said body.

3. The clamp of claim 2 further including a link having a first end pivotally coupled to said clamping member and a second end pivotally coupled to said piston.

4. The clamp of claim 2 wherein said piston translates along an axis offset and parallel to a longitudinal axis of said pin.

5. The clamp of claim 4 further including an anvil including a surface adapted to support a workpiece, said clamping member being selectively engageable with said surface to clamp the workpiece to said anvil.

6. The clamp of claim 2 further including a locking device to substantially maintain said clamping member in said second position when a fluid pressure supplied to said piston is removed.

7. The clamp of claim 6 wherein said locking device includes a spring biasing said piston to move said clamping member toward said second position.

8. The clamp of claim 6 wherein said locking device includes a locking pin selectively engageable with said piston.

9. The clamp of claim 8 wherein said locking pin include a graspable portion positioned outside of said clamp body to manually disengage said locking pin from said piston.

10. The clamp of claim 8 wherein said locking pin is biased toward engagement with said piston and selectively disengaged by application of pressurized fluid.

11. A clamp comprising:
an actuator having a linearly drivable member;
a clamp body;
a locating pin coupled to and protruding from said clamp body, said locating pin having a longitudinal axis and an arcuately shaped internal passageway, said passageway extending about an axis transversely oriented relative to said longitudinal axis; and
a clamping member slidably positioned with said passageway and drivingly coupled to said drivable member, said clamping member being moveable between a first position substantially entirely within said passageway and a second position at least partially protruding from said passageway.

12. The clamp of claim 11 wherein said actuator includes a piston slidably positioned within a bore of said body.

13. The clamp of claim 12 further including a link having a first end pivotally coupled to said clamping member and a second end pivotally coupled to said piston.

14. The clamp of claim 12 wherein said piston translates along an axis offset and parallel to a longitudinal axis of said pin.

15. The clamp of claim 12 further including a locking device to substantially maintain said clamping member in said second position when a fluid pressure supplied to said piston is removed.

16. A clamp comprising:
a clamp body;
an actuator coupled to said clamp body;
a locating pin having a passageway extending therethrough;
a clamping member positioned in said passageway, said clamping member being drivingly coupled to said actuator by a link, said clamping member being selectively moveable between a first position substantially inside said pin passageway and a second position where a portion of said clamping member extends beyond said pin; and
an anvil removably coupled to said clamp body, said anvil coupling said pin to said clamp body, wherein said link, said pin, said clamping member and said anvil are selectively disconnectable from said actuator and said clamp body by translating said anvil relative to said body.

17. The clamp of claim 16 wherein said actuator includes an axially moveable rod having a transversely extending post, a first end of said link being rotatably coupled to said post, and a second end of said link being rotatably coupled to said clamping member.

18. The clamp of claim 17 wherein said second end of said link includes a pair of bifurcated legs, said clamping member having a portion positioned between said legs.

19. The clamp of claim 18 wherein said post is integrally formed with said rod.

20. The clamp of claim 19 wherein said actuator includes a piston slidably positioned within a bore of said clamp body.

21. The clamp of claim 20 wherein said piston is integrally formed with said rod.

22. The clamp of claim 16 wherein said anvil is positioned within a slot formed in said body.

23. The clamp of claim 22 wherein said anvil includes a pair of opposing substantially parallel walls, said walls engaging said slot.

24. The clamp of claim 16 wherein said anvil includes a downstanding boss positioned in a recess of said clamp body.

25. The clamp of claim 24 wherein said boss includes an outer surface in engagement with an upstanding wall of said clamp body.

26. The clamp of claim 24 wherein said anvil is selectively moveable within said recess.

27. The clamp of claim 16 wherein said anvil includes a stepped end positioned within a recess of said clamp body, wherein said anvil is free to move in a transverse direction relative to said clamp body and restrained from moving in a direction opposite said transverse direction.

28. The clamp of claim 27 wherein said anvil includes an internal slot to allow relative transverse movement between said piston and said anvil.

29. A method of operating a clamp having an actuator, a clamp body, a locating pin having a passageway extending therethrough and a clamping member positioned within the passageway and drivingly coupled to the actuator, the method comprising:
linearly translating the actuator;
selectively moving the clamping member between a first position within the pin passageway and a second position where a portion of the clamping member is outside of the pin passageway, wherein said clamping member travels circumferentially about an axis positioned transversely to the travel path of the actuator.

30. The method of claim 29 further including supplying pressurized fluid to a chamber formed in the clamp body, said pressurized fluid providing energy to translate the actuator.

31. The method of claim 30 wherein the actuator includes a piston slidably moveable within said chamber.

32. The method of claim 31 further including interconnecting said piston and the clamping member with a link.

33. The method of claim 32 further including supplying a retention force to maintain the clamping member in said second position after said pressurized fluid supply is discontinued.

34. The method of claim 33 further including replacing the locating pin by axially translating an anvil coupled to said pin and disconnecting the clamping member from said piston during said translating of said anvil.
